(19) United States
(12) Patent Application Publication
(10) Pub. No.: US 2026/0051547 A1
(43) Pub. Date: Feb. 19, 2026

(54) AQUEOUS ELECTROCHEMICAL DEVICES AND PREPARATION METHOD THEREOF

(71) Applicant: THE UNIVERSITY OF ADELAIDE, Adelaide (AU)

(72) Inventors: Shizhang QIAO, Adelaide (AU); Han WU, Adelaide (AU)

(21) Appl. No.: 19/101,658

(22) PCT Filed: Aug. 8, 2023
(86) PCT No.: PCT/AU2023/050742

§ 371 Date: Feb. 6, 2025

(30) Foreign Application Priority Data
Aug. 8, 2022 (AU) 2022902227

(51) Int. Cl. H01M 10/42; H01M 4/36; H01M 4/58; H01M 10/26

(52) U.S. Cl. CPC H01M 10/4235; H01M 4/366; H01M 4/58; H01M 10/26; H01M 2300/0014

(57) ABSTRACT

The disclosure relates to an aqueous electrochemical device comprising a negative electrode, a positive electrode, a separator and an aqueous electrolyte having an alkaline pH, wherein onto the positive electrode is disposed at least one layer of nanoparticles capable of being used to form a local hydronium ion rich environment at the positive electrode during operation of the device, and/or the capacity ratio between the negative electrode and the positive electrode is less than 1 so as to substantially avoid production of oxygen at the positive electrode. The electrochemical device may find particular use in large-scale energy storage.

### PRIORITY DOCUMENT

The present application claims priority from Australian Provisional Patent Application No. 2022902227 titled “AQUEOUS ELECTROCHEMICAL DEVICES AND PREPARATION METHOD THEREOF” and filed on 8 Aug. 2022, the content of which is hereby incorporated by reference in its entirety.

### TECHNICAL FIELD

The present disclosure relates generally to aqueous electrochemical devices and methods for their preparation. In particular, the present disclosure relates to aqueous metal ion batteries having an aqueous electrolyte with an alkaline pH and methods for their preparation.

### BACKGROUND

Energy storage will dramatically transform the way the world uses energy. In addition to being more flexible, reliable and efficient, energy storage is an effective way to smooth out the supply of variable forms of renewable energy such as solar and wind power. The demand for large-scale energy storage has grown and one of the most common forms of large-scale energy storage is batteries¹. Although organic electrolyte-based batteries show high energy densities which are, in principle, suitable for large-scale energy storage, they suffer from inherent instability and safety issues caused by usage of expensive yet highly volatile and flammable organic solvents (for example dimethyl carbonate and diethyl carbonate) and of chemically unstable and toxic salts (for example lithium hexafluorophosphate (LiPF₆))²⁻⁷.

Aqueous batteries are promising to resolve these issues and have shown enormous potential for large-scale energy storage given their cost effectiveness, high ionic conductivity and much improved safety. Attempts have been made to use aqueous metal-ion batteries, including, but not limited to, aqueous magnesium ion batteries (AMIBs), aqueous aluminium ion batteries (AAIBs), and aqueous alkali metal ion batteries such as aqueous lithium ion batteries (ALIBs), aqueous potassium ion batteries (AKIBs) and aqueous sodium ion batteries (ASIBs).

However, aqueous electrolytes have been known for their narrow electrochemical stability window (ESW, 1.23 V) due to the occurrence of the hydrogen evolution reaction (HER) and the oxygen evolution reaction (OER), which imposes an unwanted restriction on the choice of cathode and anode materials. A recently suggested strategy to expand the ESW is to use a highly concentrated “water-in-salt” (WIS) electrolyte solution⁸, which paved the way for development of a series of aqueous high-voltage rechargeable batteries. The WIS electrolyte enables a wider voltage window (3.0 V) through the formation of a solid electrolyte interphase (SEI) on the anode and suppressing hydrogen evolution at the anode. By applying an excess amount of lithium bis(trifluoromethane sulfonyl)imide (LiTFSI)], Suo et al.⁸ built an electrode-electrolyte interphase to suppress the HER as well as the special electrolyte structure which can retard the OER.

Some intrinsic characteristics make aqueous lithium ion batteries less feasible for large-scale stationary energy storage applications, where safety, cycling life and low production cost become relatively more important than energy density. Compared to lithium, sodium may be more applicable in aqueous batteries for large-scale energy storage due to its abundant reserves, low costs and rich distributions⁹.

In theory, aqueous sodium ion batteries (ASIBs) can be fabricated through simply applying the WIS strategy by using an excess amount of fluorine sodium salts. However, a desirable sodium aqueous battery cannot be achieved due to the limited solubility of sodium salts as an electrolyte component. The concentration of lithium trifluoromethanesulfonate (LiOTF) and potassium trifluoromethanesulfonate (KOTF) can reach 22 M and 20 M at 25° C. respectively, but the concentration of sodium trifluoromethanesulfonate (NaOTF) can only reach 9 M¹⁰. A huge amount of free water caused by low salt solubility is not only susceptible to oxidation, but also can compromise the stability of slightly water-soluble LiF or NaF-rich solid-electrolyte interface (SEI) in suppressing HER. Recently, some researchers have introduced alternative strategies such as bisalt or other organic compounds¹¹⁻¹³ to break through the solubility limits of sodium salts. However, many of these works involve use of expensive fluorine containing salts and organic compounds which could bring about issues like potential toxicity, corrosiveness, and increased costs for an electrolyte.

It has also been suggested to increase pH to suppress HER at the anode, but this approach leads to a compromise in stability at the cathode.^{14,15} The overall electrochemical stability window of aqueous electrolytes remains constant. The OER is highly pH-sensitive and is much more violent in alkaline conditions than in neutral conditions, as illustrated by the Pourbaix diagram.¹

Accordingly, there remains a need for aqueous batteries which could solve or alleviate one or more of the above problems and may be of practical use in large-scale energy storage.

### SUMMARY

In a first aspect, provided herein is an aqueous electrochemical device comprising a negative electrode, a positive electrode, a separator and an aqueous electrolyte having an alkaline pH, wherein the positive electrode has disposed thereon at least one layer of nanoparticles capable of forming a local hydronium ion rich environment at the positive electrode during operation of the device, and/or the capacity ratio between the negative electrode and the positive electrode is less than 1 (i.e. the N/P capacity ratio is <1) so as to substantially avoid production of oxygen at the positive electrode.

In a second aspect, provided herein is a method of fabricating an aqueous electrochemical device comprising a negative electrode, a positive electrode, a separator, and an aqueous electrolyte having an alkaline pH, wherein the method includes applying onto the positive electrode at least one layer of nanoparticles capable of forming a local hydronium ion rich environment at the positive electrode during operation of the device, and/or making the capacity ratio between the negative electrode and the positive electrode less than 1 (i.e. the N/P capacity ratio<1) so as to substantially avoid production of oxygen at the positive electrode.

In certain embodiments of the first or second aspect, the aqueous electrochemical device is an aqueous battery. In some embodiments, the aqueous battery is an aqueous metal-ion battery. In some further embodiments, the aqueous battery is an aqueous lithium-ion battery, an aqueous sodium-ion battery, or an aqueous potassium-ion battery. In some specific embodiments, the aqueous battery is an aqueous sodium-ion battery.

In certain embodiments of the first or second aspect, the at least one layer of nanoparticles is made from a support and a metal selected from the group consisting of Ni, Pt, Fe, Co, Pd, Cu and combinations thereof. In some embodiments, the support is selected from the group consisting of carbon black, carbon nanotubes, graphite, graphitised carbon black, graphene, reduced graphene oxide (rGO) and combinations thereof.

In certain embodiments of the first or second aspect, the nanoparticles are selected from the group consisting of Ni/C, Pt/C, Fe/C, Co/C, Pd/C, Cu/C, PtNi/C, PtFe/C, PtCo/C, PtCu/C, PdNi/C, Ni/rGO, Pt/rGO, Fe/rGO, Co/rGO, Pd/rGO, Cu/rGO, PtNi/rGO, and PdNi/rGO nanoparticles. In some embodiments, the nanoparticles are selected from the group consisting of Ni/C, Fe/C, Co/C, and Cu/C nanoparticles. In some further embodiments, the nanoparticles are Ni/C and/or Co/C nanoparticles with a Ni and/or Co loading of about 1% to about 40% by weight. In even further embodiments, the nanoparticles are Ni/C and/or Co/C nanoparticles with a Ni and/or Co loading of about 20% by weight.

In certain embodiments of the first or second aspect, the average particle size of the nanoparticles ranges from about 1 nm to about 100 nm. In some embodiments, the average particle size of the nanoparticles ranges from about 40 nm to about 60 nm.

In certain embodiments of the first or second aspect, the at least one layer of nanoparticles has a thickness of about 5 μm to about 100 μm.

In certain embodiments of the first or second aspect, the pH of the aqueous electrolyte is about 9 to about 13. In some embodiments, the pH of the aqueous electrolyte is about 12 to about 13.

In certain embodiments of the first or second aspect, when the aqueous electrochemical device is an aqueous sodium ion battery, the aqueous electrolyte having an alkaline pH comprises a salt as the electrolyte which is selected from sodium perchlorate (NaClO₄), sodium trifluoromethanesulfonate (NaCF₃SO₃), sodium nitrate (NaNO₃), sodium chloride (NaCl), sodium sulfate (Na₂SO₄), sodium acetate (CH₃COONa), sodium carbonate (Na₂CO₃), sodium hexafluorophosphate (NaPF₆) and combinations thereof. In some embodiments, the aqueous electrolyte having an alkaline pH is a saturated aqueous solution of sodium perchlorate.

In certain embodiments of the first or second aspect, when the aqueous electrochemical device is an aqueous sodium ion battery, the positive electrode comprises a positive electrode material which is selected from the group consisting of NaₓFe_{y}Mn_{1-y}[Fe(CN)₆]_{w}·zH₂O (1≤x≤2, 0.8≤y≤1, 0.8≤w≤1, 0.5≤z≤2), Na₂MnₓFe₁₋ₓFe(CN)₆ (0.8≤x≤1), Na₂MnₓNi₁₋ₓFe(CN)₆ (0.8≤x≤1), Na₂MnₓCo₁₋ₓFe(CN)₆ (0.8≤x≤1.0), Na₃V₂(PO₄)₂F₃, Na_{0.44}MnO₂, Na₂NiFe(CN)₆, Na₂CuFe(CN)₆, Na₂NiMn(CN)₆, Na₃V₂(PO)₄, NaMnO₂, Na_{0.66}[Mn_{0.66}Ti_{0.34}]O₂, Na₂Zn₃[Fe(CN)₆]₂, Na₃MnTi(PO₄)₃ and Na₄Fe₃(PO₄)₂(P₂O₇). In some embodiments, the positive electrode material is Na₂MnFe(CN)₆ (‘NMF’).

In certain embodiments of the first or second aspect, when the aqueous electrochemical device is an aqueous sodium ion battery, the negative electrode comprises a negative electrode material which is selected from the group consisting of NaTi₂(PO₄)₃ (‘NTP’), Na₃MnTi(PO₄)₃, NaTiOPO₄, Na₂VTi(PO₄)₃, Na₃V₂(PO₄)₃, TiSe₂, TiS₂, hard carbon and perylenetetracarboxylic diimide. In some embodiments, the negative electrode material is NaTi₂(PO₄)₃.

In certain embodiments of the first or second aspect, the capacity ratio between the negative electrode and the positive electrode is about 0.56:1 to about 0.95:1, for example about 0.62:1 and about 0.75:1. In some embodiments, the capacity ratio between the negative electrode and the positive electrode is about 0.62:1.

In certain embodiments of the first or second aspect, the aqueous electrochemical device exhibits an energy density of at least about 90 Wh kg⁻¹ at 0.5 C. In some embodiments, the aqueous electrochemical device has a cycling life of over 14,000 cycles at 10 C. In some embodiments, the aqueous electrochemical device has a cycling life of up to 200 cycles at 1 C. In some further embodiments, the aqueous electrochemical device shows a capacity retention of 86% at 0.5 C after 200 cycles at −30° C. In the case of a Na₂MnFe(CN)₆/NaTi₂(PO₄)₃ pouch cell with a similar electrode loading of about 20 mg·cm⁻², the aqueous electrochemical device exhibits an average Coulombic efficiency of 99% and retains 85% capacity after 1,000 cycles at 1 C. In the case of a 50 mAh Na₂MnFe(CN)₆/NaTi₂(PO₄)₃ pouch cell with an electrode loading over 30 mg·cm⁻², the aqueous electrochemical device demonstrates a capacity retention of nearly 100% after 200 cycles at 300 mA g⁻¹ at 25° C.

In a third aspect, provided herein is a positive electrode for an aqueous electrochemical device, which has disposed thereon at least one layer of nanoparticles capable of forming a local hydronium ion rich environment at the positive electrode during operation of the device. The nanoparticles, the at least one layer of nanoparticles, the positive electrode, and the electrochemical device may be those described for the first aspect.

In a fourth aspect, provided herein is a method of preparing a positive electrode for an aqueous electrochemical device, wherein the method includes applying onto the positive electrode at least one layer of nanoparticles capable of forming a local hydronium ion rich environment at the positive electrode during operation of the device. The nanoparticles, the at least one layer of nanoparticles, the positive electrode, and the electrochemical device may be those described for the second aspect.

### BRIEF DESCRIPTION OF THE FIGURES

Non-limiting embodiments of the present disclosure will be discussed with reference to the accompanying figures wherein:

FIG. 1 shows (a) an X-ray powder diffraction (XRD) spectrum of Ni/C, and (b) a transmission electron microscopy (TEM) image of Ni/C (PDF #04-0850).

FIG. 2 shows a linear sweep voltammetry (LSV) curve after the surface treatment of the positive electrode: Cal: 0.000174 μm/pix: 11:01 2022 Jul. 27; Camera: NANOSPRT15, Exposure: 400 (ms)×4 std. frames, Gain: 1, Bin: 1: Gamma: 1.00, No sharpening, Normal Contrast.

FIG. 3 depicts (a) discharge capacity of batteries at different rates, and (b) Coulombic efficiency of batteries at different rates.

FIG. 4 depicts electrochemical performance of the NMF/NTP full cell at voltage range of 0.5-2.2 V. (a) Rate capability at various current rates and the corresponding Coulombic efficiency of the NMF/NTP full cell using local microenvironment (LME) at room temperature. (b) Comparison of average voltage at various current rates of the NMF/NTP full cell in different system at room temperature. (c) Cycling performance of NMF/NTP full cell in different systems at current rate of 1 C at room temperature. (d) Cycling performance of NMF/NTP full cell in different systems at a current rate of 0.5 C and at −30° C. (e) Long-term cycling performance of the NMF/NTP full cell using local environment at a current rate of 10 C and at room temperature (cathode mass loading: 20.45 mg· cm⁻², anode mass loading: 19.45 mg·cm⁻², the mass of negative electrode material comprised by the negative electrode and the mass of positive electrode material comprised by the positive electrode is at a ratio of about 0.95:1).

FIG. 5 depicts cycling performance (a) discharge capacity, and (b) coulombic efficiency of NMF/NTP full batteries at 0.5 C.

FIG. 6 shows a comparison of reported sodium aqueous batteries with the batteries according to the present disclosure.

FIG. 7 shows a comparison of the batteries according to the present disclosure with previously reported batteries in terms of cost and electrochemical performance. (a) Comparison of the total cost for the full battery with reported aqueous Li, Na and K-ion full batteries (the prices are based on the sigma in Australia, Table 1). (b) Comparison of lifespan and energy density for our works with reported aqueous Na and K-ion full batteries. (c) Comparison of batteries according to the present disclosure with commercial batteries as quantified in Table 2.

FIG. 8 shows a safety test of ASIB pouch cell using the surface treatment of the positive electrode. (a) Output voltage of pouch cell. (b) Picture of blue lights powered by two ASIB pouch cells. (c) Picture of cut pouch cells immersed in water to power blue lights. (d) Charge-discharge curves of 32 mAh ASIB pouch cell. (e) Picture of electric fan powered by ASIB pouch cell. (f) Charge curves of ASIB pouch cell before and after being cut and immersed in water. (g-i) A cut pouch cell after being recharged powers the temperature hygrometer in water over 10 h.

FIG. 9 depicts the generation of a local environment. (a) In-situ surface-enhanced IR spectra of C at different potentials. (b) In-situ surface-enhanced IR spectra of Ni/C at different potentials. (c) operando differential electrochemical mass spectrometry (DEMS) results to evaluate the H₂ and O₂ evolution during NMF/NTP battery cycling at the voltage range of 0.5 V to 2.2 V at 0.5 C. (d) Scanning electron microscope cross-section image of Ni/C coated NMF. (c) Schematic illustration of the water reduction mechanism on the electrode surface with pure carbon and Ni/C in the alkaline electrolyte.

FIG. 10 shows in-situ Fourier-transform infrared spectroscopy (FTIR) for C and Ni/C in neutral electrolytes.

FIG. 11 shows the investigation of the reaction mechanism and in situ Ni substitution. The charge-discharge curves of the NMF/NTP electrodes in (a) neutral electrolyte, (b) alkaline electrolyte, (c) alkaline electrolyte with the surface treatment of the positive electrode strategy. (d) TEM image of NMF electrode after being cycled in neutral electrolyte, alkaline electrolyte and alkaline electrolyte with the surface treatment of the positive electrode strategy. (c) Energy-dispersive X-ray spectroscopy (EDS) spectra taken from the NMF electrodes after being cycled in neutral electrolyte, alkaline electrolyte and alkaline electrolyte with the surface treatment of the positive electrode strategy. (f) Raman spectra of the NMF electrodes after being cycled in neutral electrolyte, alkaline electrolyte and alkaline electrolyte with the surface treatment of the positive electrode strategy.

FIG. 12 depicts electrochemical performance of the NMF/NTP full cell at voltage range of 0.5-2.2 V. (a). (c) and (e) cycling performance of NMF/NTP full cell with a layer of Pd/C, Cu/C or Co/C nanoparticles on the positive electrode at current rate of 1 C at 25° C. (b), (d) and (f) charge/discharge curves of NMF/NTP full cell with a layer of Pd/C (b), Cu/C (d) or Co/C (f) nanoparticles on the positive electrode.

FIG. 13 depicts cycling performance of NMF/NTP full cell with a NTP/NMF ratio of 1:1 and of a NMF/NTP full cell with a NTP/NMF ratio of 0.75:1.

FIG. 14 depicts cycling performance of NMF/NTP full cell with a NTP/NMF ratio of 1:1 and of a NMF/NTP full cell with a NTP/NMF ratio of 0.62:1.

FIG. 15 depicts cycling performance of NMF/NTP full cell with a NTP/NMF ratio of 1:1 and of a NMF/NTP full cell with a NTP/NMF/ratio of 0.56:1.

### DESCRIPTION OF EMBODIMENTS

The term “electrochemical device” used herein refers to a device that can convert chemical energy into electrical energy through an electrochemical reaction.

The term “aqueous electrolyte” used herein generally refers to a water-based electrolyte solution. However, this does not exclude the possibility of presence of an amount of organic co-solvent (such as dimethyl carbonate (DMC) and acetonitrile) that would not have adverse impact on forming a local hydronium ion rich environment at the positive electrode with the aid of at least one layer of nanoparticles disposed onto the positive electrode.

The term “water-in-salt electrolyte” used herein refers to a highly concentrated electrolyte solution wherein the dissolved salt molecules greatly outnumber water molecules (salt/solvent ratio>1 by volume or weight) and there are barely enough water molecules available to form the “classical” primary solvation.

The term “negative electrode material” used herein refers to an active material for the negative electrode of the electrochemical device. The term “positive electrode material” used herein refers to an active material for the positive electrode of the electrochemical device.

The phrase “hydronium ion rich” used herein means that H₃O⁺ ions accumulate at the surface of a positive electrode, which may be evidenced by the asymmetric O—H stretching modes of H₃O⁺ at 2020 cm⁻¹ as well as the umbrella vibration of H₃O⁺ at 1230 cm⁻¹ via in-situ IR. It will be appreciated that a hydronium ion rich environment at the positive electrode results in a local acidic environment at the electrode.

The term “capacity” used in relation to an electrode refers to the total amount of electricity generated due to an electrochemical reaction at an electrode. It may be determined by the usable amount (e.g. mass) of active material of an electrode that participates in the redox reactions.

The term “capacity ratio between the negative electrode and the positive electrode” used herein is also known and referred to in the art as the N/P capacity ratio.

The disclosure arises from the inventors' research into stabilisation of aqueous electrochemical devices. It has been surprisingly found that forming a local hydronium ion rich environment at a positive electrode (cathode) in an alkaline (or high pH) electrolyte during operation of the device can suppress oxygen production at the positive electrode while the alkalinity of the electrolyte is helpful in retarding hydrogen production at the negative electrode (anode). In this way, the electrochemical stability window (ESW) of an aqueous electrolyte can be expanded and the stability of an aqueous electrochemical device is improved. By way of example in a case where an Mn-rich Prussian Blue Analogue (PBA) such as Na:MnFe(CN)₆ was used as the positive electrode material and at least one layer of Ni-based nanoparticles was disposed on the positive electrode, the edges of Ni-based nanoparticles prompted the dissociation of water and large amounts of H* were produced. However, under a positive potential. H* is hard to adsorb onto the surface of the positive electrode, and instead. H ions are still bonded to nearby water molecules but not to the surface of the catalyst. Thus, hydronium ions (H₃O⁺) accumulated at the surface of the positive electrode to form a local acidic environment. This H₃O⁺ rich environment may effectively restrain the OH in the bulk electrolyte from contacting the positive electrode, so that the OER at the positive electrode is suppressed. The H₃O⁺ rich environment may also retard the OH species adsorbing onto the surface of the positive electrode, thereby weakening the dissolution of Mn and stabilising the positive electrode. During charging, oxidisation of Ni-based nanoparticles in the layer(s) has been found to promote in-situ substitution of Ni²⁺ for Mn which then further enhances the stability of the aqueous electrochemical device. It has also been surprisingly found that making the capacity ratio between the negative electrode and the positive electrode (i.e. the N/P capacity ratio) less than 1 allows the voltage of the electrochemical device to be altered to a voltage range at which hydrogen is more likely produced and production of oxygen at the positive electrode is substantially avoided. This cathode sacrifice strategy combined with an alkaline pH (or high pH) electrolyte, which assists in suppressing production of hydrogen at the negative electrode, may significantly improve the stability of aqueous electrochemical devices.

Accordingly, disclosed herein is an aqueous electrochemical device comprising a negative electrode, a positive electrode, a separator, and an aqueous electrolyte having an alkaline pH. There is at least one layer of nanoparticles disposed onto the positive electrode which are capable of being used to form a local hydronium ion rich environment at the positive electrode during operation of the device. In addition or alternatively, the capacity ratio between the negative electrode and the positive electrode is selected to be less than 1 so as to substantially avoid production of oxygen at the positive electrode.

The aqueous electrochemical device disclosed herein may be in the form of a battery or a cell. For the purpose of illustration, aqueous batteries may include aqueous magnesium-ion batteries (AMIBs), aqueous aluminium-ion batteries (AAIBs), and aqueous alkali metal-ion batteries such as aqueous lithium-ion batteries (ALIBs), aqueous potassium-ion batteries (AKIBs) and aqueous sodium-ion batteries (ASIBs). In some embodiments, the aqueous electrochemical device may be ALIBs as they tend to have a high energy density. In some other embodiments, aqueous sodium-ion batteries (ASIBs) may be preferable because of an abundance of raw materials, safety and low costs.

As explained above, the electrochemical stability window of aqueous batteries is as narrow as ˜1.23V, which restricts the selection of a negative electrode material and a positive electrode material due to the occurrence of hydrogen and/or oxygen production reactions. Ideally, the redox potentials of electrodes should lie in between the hydrogen and oxygen production potentials to avoid the electrolysis of water.

Generally, negative electrode materials and positive electrode materials for aqueous batteries that are known in the art can be used for the present disclosure. Examples of the negative electrode material for aqueous lithium-ion batteries include conductive additives. LTO (lithium titanate), surface-functionalized silicon, and high-performance powdered graphene. A lithium metal oxide compound, such as lithium cobalt dioxide LiCoO₂, lithium nickel dioxide LiNiO₂, lithium manganese dioxide LiMnO₂, lithium manganese oxide LiMn₂O₄, lithium nickel manganese oxide Li_{1.0}Ni_{0.5}Mn_{1.5}O₄, lithium nickel manganese cobalt oxide LiNi_{0.33}Mn_{0.33}Co_{0.33}O₂, or high energy lithium nickel manganese cobalt oxide Li_{1.2}Ni_{0.176}Mn_{0.524}Co_{0.100}O₂, is normally used as the positive electrode material. Consideration may also be given to FeS₂ and lithium ion phosphate, etc. If needed, elemental doping and coatings can be applied to modify the electrode materials.

Turning to aqueous sodium-ion batteries, the negative electrode material may be selected from NaTi₂(PO₄)₃ (NTP). Na₃MnTi(PO₄)₃, NaTiOPO₄, Na₂VTi(PO₄)₃, Na₃V₂(PO₄)₃, TiSe₂, TiS₂, hard carbon and perylenetetracarboxylic diimide. In some embodiments, the negative electrode material is NaTi₂(PO₄)₃. Among the positive electrode materials that can be used to fabricate aqueous sodium ion batteries disclosed herein. Prussian Blue Analogues (PBA) are promising because of their excellent redox properties and relatively high standard potential. For ASIBs. PBA may have the general formula NaₓP[R(CN)₆]_{1-y}·wH₂O where P and R are transition metals such as Mn, Ni and Fe, and y is the number of [R(CN)₆] vacancies. The cage-like structure exhibits wide channels, allowing for insertion of a wide range of intercalation ions. PBA can be prepared from abundant and non-toxic elements by simple and low-cost co-precipitation synthesis of a metal salt and a hexacyanoferrate complex. In this regard. NaₓFe_{y}Mn_{1-y}[Fe(CN)₆]_{w}·zH₂O (1≤x≤2.0.8≤y≤1.0.8≤w≤1.0.5≤z≤2), Na₂NiFe(CN)₆, Na₂MnₓFe₁₋ₓFe(CN)₆ (0.8≤x≤1) such as Na₂MnFe(CN)₆ (NMF), Na₂MnₓNi₁₋ₓFe(CN)₆ (0.8≤x≤1). Na₂Zn₃[Fe(CN)₆]₂, Na₂CuFe(CN)₆ and/or Na₂NiMn(CN)₆ may be chosen as the positive electrode material. Other examples of the positive electrode material that can be useful for the aqueous sodium ion batteries disclosed herein include, but are not limited to. Na_{0.44}MnO₂, Na₃V₂(PO)₄, NaMnO₂, Na_{0.66}[Mn_{0.66}Ti_{0.34}]O₂, Na₃MnTi(PO₄)₃, Na₂MnₓCo₁₋ₓFe(CN)₆ (0.8≤x≤1.0), Na₃V₂(PO₄)₂F₃, and Na₄Fe₃(PO₄)₂(P₂O₇).

In order to suppress oxygen production at the positive electrode, the capacity ratio between the negative electrode and the positive electrode may be chosen to be less than 1. In some cases, such as in a NMF/NTP full cell, this can be achieved through making the mass ratio between the negative electrode material of the negative electrode and positive electrode material of the positive electrode in the range of about 0.56:1 to about 0.95:1, for example, about 0.62:1 and about 0.75:1. When the mass ratio is reduced to about 0.62:1, the electrochemical device disclosed herein may experience substantially no capacity fading after 160 cycles in 1 C at 25° C. This strategy is to improve the mass of the positive electrode and make it surpass the mass of the negative electrode to alter the voltage of the electrochemical device to a voltage at which only H₂ is produced and generation of O₂ is avoided. Furthermore, improving the alkalinity of the electrolyte can also help suppress the H₂ production. Then desirable stability may be achieved with the electrochemical device.

The positive electrode and the negative electrode can be fabricated by any method known in the art. For instance, an electrode can be prepared by compressing a mixture of an active material, a support material (such as carbon black) and a binder (such as polytetrafluoroethylene) against a stainless steel grid or a titanium (Ti) mesh. Alternatively, an electrode can be fabricated by applying a coating slurry onto a metallic foil (e.g. titanium (Ti), copper (Cu) and aluminium (Al)) or a carbon paper wherein the coating slurry contains an organic solvent, an active material, conducting particles and a binder.

For the electrochemical device disclosed herein, at least one layer of nanoparticles is disposed onto the positive electrode. The at least one layer of nanoparticles is capable of being used to form a local hydronium ion rich environment and thereby suppressing oxygen production at the positive electrode during operation of the device. Without being bound by any theory, it is believed that nanoparticles such as Ni-based nanoparticles can promote water dissociation and, as a result, large amounts of H⁺ and OH⁻ are produced in the at least one layer of nanoparticles due to the water dissociation. Then the strong interaction between Ni and OH helps to confine OH to the surface of the nanoparticle layer rather than escape to the surrounding electrolyte. However. H⁺ has a poor interaction with Ni nanoparticles and they will tend to bond with the nearby water molecules to form H₃O⁺ around the nanoparticles layer, which leads to a local H₃O⁺ rich environment.

The nanoparticles used herein may be based on Ni, Pt, Fe, Co, Pd and/or Cu and may further contain a support. Examples of the support within the nanoparticles include, but are not limited to, carbon black, carbon nanotubes, graphite, graphitised carbon black, graphene, reduced graphene oxide (rGO) and combinations thereof. To form a layer of these nanoparticles, it is possible to use a membrane substance such as Nafion-Na. Nafion™ perfluorosulfonic acid (PFSA) membranes are based on a PFSA/polytetrafluoroethylene (PTFE) copolymer and have low ion transport resistance. Nafion™ products are commercially available from Chemours (formerly DuPont), Delaware, United States and in the types of Nafion™ 117. Nafion™ 115, Nafion™ 212, Nafion™ 211, etc.

In some embodiments, the nanoparticles used herein may include Ni/C, Pt/C, Fe/C, Co/C, Pd/C, Cu/C, PtNi/C, PtFe/C, PtCo/C, PtCu/C, PdNi/C, Ni/rGO, Pt/rGO, Fe/rGO, Co/rGO, Cu/rGO, Pd/rGO, PtNi/rGO and PdNi/rGO nanoparticles. In some specific embodiments, the nanoparticles are selected from the group consisting of Ni/C, Fe/C, Co/C and Cu/C nanoparticles. Taking the Ni/C nanoparticles as an example, they can be nanoparticles with a Ni loading of about 1% by weight to about 40% by weight, for example, about 5% by weight, 10% by weight, 15% by weight, 20% by weight. 25% by weight, 30% by weight, 35% by weight, 40% by weight. It may be preferable that the nanoparticles are Ni/C nanoparticles and/or Co/C nanoparticles, and that the Ni loading and/or the Co loading is about 1% by weight to about 40% by weight, for example about 20% by weight. Many of the nanoparticles mentioned herein are commercially available from Fuel Cell Store, Texas, United States of America. Non-limiting examples are 10% Nickel on Vulcan, 20% Nickel on Vulcan, 40% Nickel on Vulcan, 10% Iron on Vulcan, 10% Cobalt on Vulcan, and 40% Platinum Nickel (1:1 ratio) on Vulcan.

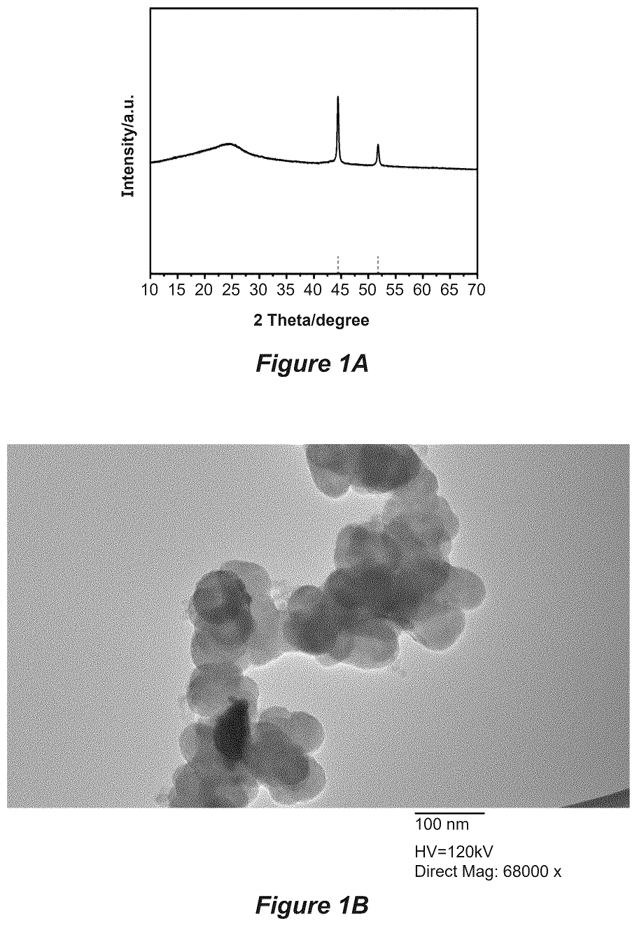

It is possible for the nanoparticles to have an average particle size ranging from about 1 nm to about 100 nm. In some embodiments, the average particle size of the nanoparticles ranges from 40 nm to 60 nm. The average particle size may be determined by means of, for example, transmission electron microscopy (TEM). See FIG. 1 (b).

The at least one layer of nanoparticles may have a thickness of about 5 μm to about 100 μm. If it is too thick, the cost will increase and the capability of ion transportation will be compromised. If it is too thin, the at least one layer of nanoparticles might not be sufficient to form a local hydronium ion rich environment at the positive electrode. Measurement of the thickness can be performed by use of a spectrometer.

The nanoparticles described above can be disposed onto the positive electrode by solution casting. For example, nanoparticles, a membrane substance and a solvent are combined to prepare a solution, which is then cast onto the positive electrode. After the solvent is removed, the positive electrode will be coated with a layer of the nanoparticles.

The negative electrode and the positive electrode are connected to each other by an aqueous electrolyte. The aqueous electrolyte for the electrochemical device disclosed herein is required to have an alkaline pH. It is believed that increasing the pH is helpful to effectively suppress hydrogen production at the anode. For the purpose of the present disclosure, the pH of the aqueous electrolyte may be chosen to be about 9 to about 13, for example about 9, 9.5, 10, 10.5, 11, 11.5, 12, 12.5 and 13. In some embodiments, the pH of the aqueous electrolyte is about 12 to about 13. The aqueous electrolyte can be adjusted to a desirable pH by use of a suitable alkaline, for example, NaOH and KOH.

The electrolyte plays a key role in transporting positive ions between the positive electrode and the negative electrode. In choosing an electrolyte for the aqueous electrolyte, at least the following factors may be considered: (i) chemical inertness: (ii) wide liquidus range and thermal stability: (iii) wide electrochemical stability window: (iv) high ionic and no electronic conductivity: (v) interphase properties; and (vi) availability. In some circumstances, it may be desirable for the electrolyte disclosed herein to be modified by introducing corrosion inhibitors or complexing agents in order to make the electrolyte less corrosive. It is also possible to introduce an additive into the aqueous electrolyte to optimise electrochemical performance in the electrochemical device disclosed herein. For the purpose of illustration, the electrolyte to be used for ALIBs may include LiPF₆, LiClO₄. LiAsF₆, lithium bis(fluorosulfonyl)imide (LiFSI), lithium bis(trifluoromethylsulfonyl)imide (LiTFSI), LiCF₃SO₃ and combinations thereof. The electrolyte to be used for ASIBs may include sodium perchlorate (NaClO₄), sodium trifluoromethanesulfonate (NaCF₃SO₃), sodium bis(fluorosulfonyl)imide (NaFSI), sodium bis(trifluoromethylsulfonyl)imide (NaTFSI), sodium nitrate (NaNO₃), sodium sulphate (NaSO₄), sodium chloride (NaCl), sodium acetate (CH₃COONa), sodium carbonate (Na₂CO₃), sodium hexafluorophosphate (NaPF₆) and combinations thereof. NaClO₄ may be a preferred electrolyte salt for a low-cost, high-voltage sodium aqueous electrolyte with a wide electrochemical stability window.

In the case that the aqueous electrochemical device is an aqueous sodium ion battery, the aqueous electrolyte having an alkaline pH may be a water-in-salt electrolyte solution. It is believed that the formation of a solid electrolyte interphase layer with a high salt concentration on the electrode surface can prevent water reduction, thus positively contributing to a wide electrochemical stability window. Preferably, the salt is selected from sodium perchlorate (NaClO₄), sodium trifluoromethanesulfonate (NaCF₃SO₃), sodium nitrate (NaNO₃), sodium chloride (NaCl), sodium sulfate (Na₂SO₄), sodium acetate (CH₃COONa), sodium carbonate (Na₂CO₃), sodium hexafluorophosphate (NaPF₆) and combinations thereof. More preferably, the water-in-salt electrolyte solution is a saturated aqueous solution of sodium perchlorate. That is, the concentration of sodium perchlorate in the water-in-salt electrolyte is about 17 mol/kg at 25° C. which is the highest among the other common sodium salts such as CH₃COONa: 5.7 mol/kg: NaCl: 6.1 mol/kg. NaNO₃: 10.3 mol/kg.

In fabricating the electrochemical device disclosed herein, other components such as a separator, a binder, a conductive agent and a current collector may be employed. A separator serves to provide a barrier with no electrical conductivity between the negative electrode (anode) and the positive electrode (cathode) while allowing ion transport from one electrode to the other electrode. The separator is expected to retain chemical stability in the electrolyte while also having a high affinity for the electrolyte. Non-limiting examples of the separator include glass fibre separators, polyolefin separators and nonwoven separators. When powdered materials are used for the electrodes, a binder may be added in the electrodes to bring various components together and provide consistent mixing of electrode components so as to allow the electrodes to conduct the requisite amount of electrons and guarantee electronic contact during cycling of the electrochemical device. Non-limiting examples of the binder include polytetrafluoroethylene (PTFE), polyvinylidene fluoride (PVDF) and carboxymethyl cellulose (CMC). A conductive agent may be used to enhance conductivity of an electrode, examples of which include, but are not limited to, carbon black, Ketjen black, graphene, conductive nano carbon fiber (VGCF), carbon nanotubes (CNTs), and multi-walled carbon nanotubes (MWCNTs). A current collector is a bridging component that collects electrical current generated at the electrodes and connects with external circuits. It could have great influence on capacity, rate capability and long-term stability of the electrochemical device. Non-limiting examples of the current collector include aluminium (Al) foil, copper (Cu) foil, Titanium (Ti) mesh, stainless steel mesh, carbon-coated aluminium, carbonaceous materials.

The aqueous electrochemical device disclosed herein may be advantageous in many aspects and especially achieve significant improvement in electrochemical performance and stability. Therefore, the aqueous electrochemical device disclosed herein is very promising to satisfy the stringent requirements about electrochemical performance, stability, cost effectiveness and safety.

In particular, the aqueous electrochemical device may exhibit an energy density of about 82 Wh kg⁻¹ at 0.5 C or even at least about 90 Wh kg⁻¹ at 0.5 C. Energy density is the measure of how much energy the electrochemical device contains in proportion to its weight. The energy density can be calculated using the formula: Average Battery Discharge Voltage (V) x Battery Discharge Specific Capacity (mAh)/Total Weight of Electrodes (g)=Specific Energy or Energy Density (Wh/kg).

In addition, or alternatively, the aqueous electrochemical device may have a cycling life over 14,000 cycles at 10 C (1 C=118 mA/g). In some instances, the aqueous electrochemical device may have a cycling life of up to 200 cycles at 1 C, for example 200 cycles at 1 C, 150 cycles at 1 C and 100 cycles at 1 C. The cycling life is the number of charge and discharge cycles that the electrochemical device can complete before losing performance. The voltage range is 0.5 to 2.2 V, and the temperature is 25° C. The batteries are first charged to 2.2 V and then discharged to 0.5 V at 25° C.

In addition, or alternatively, the aqueous electrochemical device may show a capacity retention of 86% at 0.5 C after 200 cycles at −30° C. (Voltage range: 0.5 V to 2.2 V). Moreover, the aqueous electrochemical device may demonstrate a high capacity of 32 mAh and superior stability under harsh conditions.

In the case of a Na₂MnFe(CN)₆/NaTi₂(PO₄)₃ pouch cell with a similar electrode loading of about 20 mg cm⁻², the aqueous electrochemical device may exhibit an average Coulombic efficiency of 99% and retains 85% capacity after 1,000 cycles at 1 C. In the case of a 50 mAh Na₂MnFe(CN)₆/NaTi₂ (PO₄)₃ pouch cell with an electrode loading over 30 mg·cm⁻², the aqueous electrochemical device may demonstrate a capacity retention of nearly 100% after 200 cycles at 300 mA g-1 at 25° C.

On this basis, a method of fabricating an aqueous electrochemical device comprising a negative electrode, a positive electrode, a separator, and an aqueous electrolyte having an alkaline pH has been developed. The method includes applying onto the positive electrode at least one layer of nanoparticles capable of forming a local hydronium ion rich environment at the positive electrode during operation of the device, and/or making the capacity ratio between the negative electrode and the positive electrode less than 1 (i.e. the N/P capacity ratio<1) so as to substantially avoid production of oxygen at the positive electrode. Methods of fabricating an electrochemical device, such as a battery, are known in the art and can be adapted to the present disclosure. The at least one layer of nanoparticles that is used to form a local hydronium ion rich environment at the positive electrode can be properly selected and applied onto the positive electrode with reference to the detailed description herein and the Examples.

Also disclosed herein is a positive electrode for an aqueous electrochemical device, which has disposed thereon at least one layer of nanoparticles capable of forming a local hydronium ion rich environment at the positive electrode during operation of the device. The nanoparticles, the at least one layer of nanoparticles, the positive electrode, and the electrochemical device may be those described herein above.

Also disclosed herein is a method of preparing a positive electrode for an aqueous electrochemical device, wherein the method includes applying onto the positive electrode at least one layer of nanoparticles capable of forming a local hydronium ion rich environment at the positive electrode during operation of the device. The nanoparticles, the at least one layer of nanoparticles, the positive electrode, and the electrochemical device may be those described herein above.

Surface treatment of the positive electrode by the at least one layer of nanoparticles can induce a local hydronium ion rich environment at the positive electrode in an aqueous electrolyte with an alkaline pH. It has been found by the inventors that this surface treatment may be used to suppress oxygen production at the positive electrode and stabilise the positive electrode. In the case of a Mn-rich Prussian Blue Analogue (PBA) such as Na₂MnFe(CN)₆ as a positive electrode material and at least one layer of Ni-based nanoparticles disposed onto the positive electrode, it has been found by the inventors that formation of a local hydronium ion rich environment at the positive electrode in an alkaline (or high pH) electrolyte can also facilitate in-situ substitution of Ni²⁺ for Mn and thereby enhance stability of an aqueous electrochemical device. On this basis, significant improvement in electrochemical performance and stability of the aqueous electrochemical device can be achieved. In addition, or alternatively, the capacity ratio between the negative electrode and the positive electrode can be selected to be less than 1 so as to substantially avoid production of oxygen at the positive electrode. This cathode sacrifice strategy combined with an alkaline pH (or high pH) electrolyte which assists in suppressing production of hydrogen at the negative electrode may also contribute to improvement in electrochemical performance and stability of the aqueous electrochemical device. It is expected that the aqueous electrochemical device disclosed herein may find particular use in large-scale energy storage.

### EXAMPLES

### Experiments in Relation to Application of at Least One Layer of Nanoparticles

### Preparation of Materials

Na₂MnFe(CN)₆ was synthesized by a co-precipitation method¹⁷. 5 mmol Na Fe(CN)₆ (Sigma-aldrich) and 15 g NaCl (Sigma-aldrich) were dissolved into 100 mL deionized water to form solution A. 5 mmol MnCl₂ (Sigma-aldrich) was dissolved into 50 mL deionized water to form solution B. Then, solution B was slowly (over about 20 minutes) dropped into solution A with stirring, and then stirring was continued for 2 h. The solid phase was obtained by centrifuging the prepared solution and washing three times with 30 mL of deionized water. Then, the solid phase was dried and ground into a powder, and dried in a vacuum oven at 110° C. for 24 hours before use.

NaTi₂(PO₄)₃/C was synthesized via a sol-gel method¹⁷. Typically, 2.5 mmol CH₃COONa·3H₂O (Sigma-aldrich) and 7.5 mmol NH₄H₂PO₄ (Sigma-aldrich) were dissolved into 100 mL deionized water to form solution C. 0.4 g polyvinylpyrrolidone (Sigma-aldrich) and 5 mmol Ti(CH₃CH₂CH₂CH₂O)₄ (TCI) (Sigma-aldrich) were dissolved in 50 mL anhydrous ethanol to form solution D. Next, solution D was poured into solution C quickly with rigorous stirring, and the resulting mixed solution was stirred continuously for 3 hours and was evaporated to remove the solvent at 80° C. in order to prepare the precursor. The obtained precursor was ground and calcined at 800° C. for 12 hours in an argon flow to obtain the NTP/C composite. The carbon content of the NTP/C composite was 5%.

Nafion-Na was prepared by the following method: the purchased Nafion™ 115 (DuPont, D520, 5 wt %) was neutralized to pH=7 by 0.01 M NaOH solution drop by drop. Subsequently, the solution was ion exchanged in distilled water for 12 h. Finally, the product was collected after removing the solvent at 60° C.

Preparation of Na₂MnFe(CN)₆ (NMF) Positive Electrode and NaTi₂(PO₄)₃ (NTP) Negative Electrode

The positive electrode using NMF was prepared by mechanically mixing 80 wt % NMF, 10 wt % SuperP carbon black, and 10 wt % polytetrafluoroethylene (PTFE) binder dispersed in ethanol solvent. Then the mixture was pressed on a Ti-mesh at a pressure of 6 MPa and dried at 70° C. for 2 h. The NTP negative electrode was prepared by the same procedure with 80 wt % NTP, 10 wt % SuperP carbon black, and 10 wt % PTFE. The mass loading of electrodes is ˜20 mg/cm². The N/P is ˜1.05-1.

### Preparation of Aqueous Electrolyte

41.6 g NaClO₄ was dissolved in 20 mL water to obtain 17 M NaClO₄. An alkaline electrolyte is obtained by adding a desired amount (0.1 mL, 0.2 mL, 0.4 mL) of 1 mol/L NaOH water solution into 30 mL of 17 m NaClO₄. The pH of the electrolyte is 12.75. To eliminate the influence of concentration changes, the same amount (0.1 mL, 0.2 mL, 0.4 mL) of pure water was added into 17 M NaClO₄ to obtain a neutral electrolyte.

Application of a Layer of Nanoparticles onto the Positive Electrode

A solution of nanoparticles was prepared as follows: 0.1 g Nafion-Na was dissolved in 0.45 g N, N-Dimethylformamide (DMF) and 0.9 g isopropanol mixed solution at 60° C.; then 0.025 g Ni/C (with a 20% Ni loading, purchased from Fuel Cell Store, Texas, United States of America) was added into the above solution and stirred for 0.5 hours and sonicated for 0.5 hours. The above procedures were repeated three times to obtain an even mixture. Then, 10 μL of the solution was dropped on the surface of positive electrode discs. After removing the solvent at room temperature, the positive electrode discs were coated with a layer of the Ni-based nanoparticles. The particles-size of Ni-based nanoparticles is about 50 nm, and the thickness of the nanoparticles layer is about 5 μm.

### Assembly of a Coin Cell

The negative electrode was placed on a smaller cell cap. A glass fiber separator was disposed onto the negative electrode as centered as possible, and a desired amount of electrolyte was dropped onto the separator. A positive electrode was placed on top of the separator, with the cast nanoparticle layer facing the negative electrode. The positive electrode was centered as much as possible with the negative electrode to avoid uneven current densities. A stainless steel mesh and a spring were placed in order. A larger cap was placed on top and pressed to seal.

### Assembly of a Pouch Cell

A pouch cell was assembled by using a stacking machine, the glass fibre separator was placed between the electrodes, forming a stack that was inserted in the pouch. The sides of the pouch were joined together by heat sealing, leaving one side open. An electrolyte filling system was then used to add a liquid electrolyte into the cell. Then the cell was sealed using a vacuum sealing machine, and the pouch cell assembly was complete.

### Results

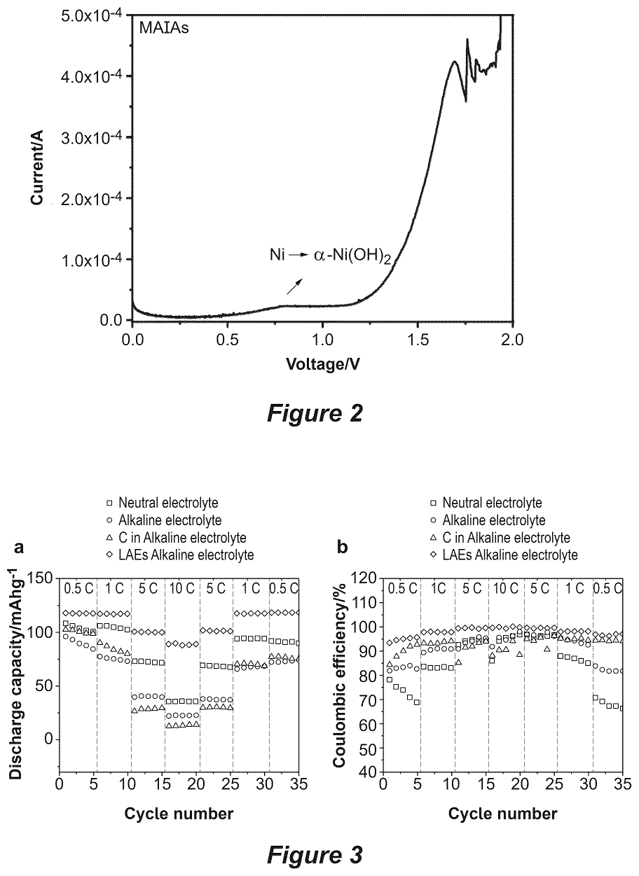

It is shown by FIG. 1 and FIG. 2 that after applying a layer of 20% Ni/C nanoparticles to create a local hydronium ion rich environment at the positive electrode, the onset of OER has been pushed from 1 V to 1.2 V.

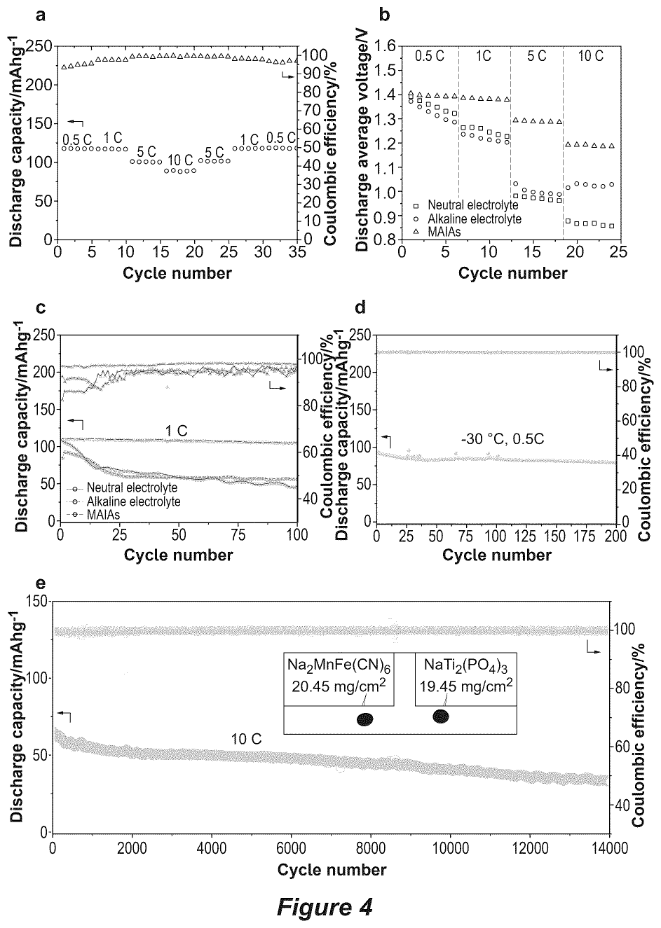

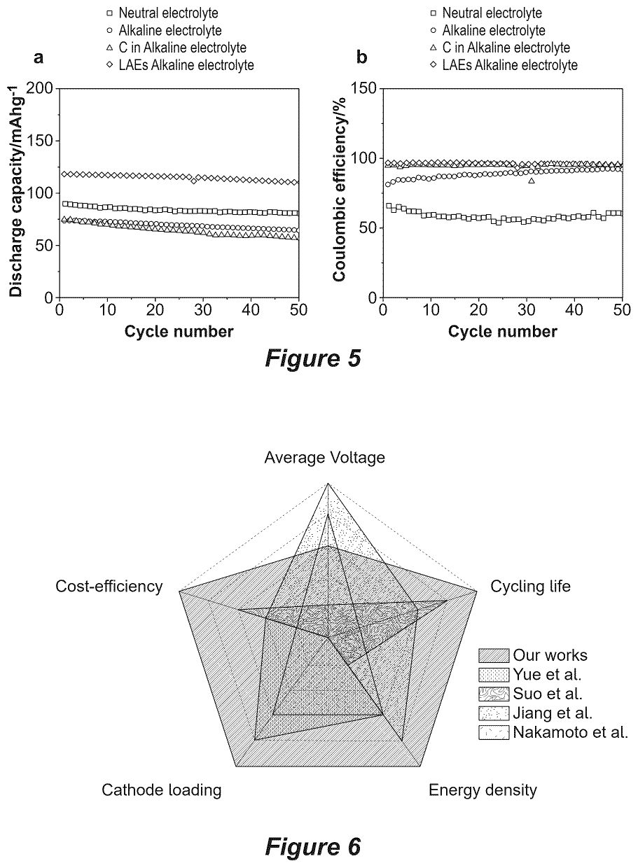

Application of a layer of Ni/C nanoparticles to create a local hydronium ion rich environment at the positive electrode in sodium aqueous batteries has unexpectedly improved the electrochemical performance of NMF/NTP cells. As shown in FIG. 3. NMF/NTP full cells cycled in neutral and alkaline electrolyte displayed a very poor rate performance, as well as the low Coulombic efficiency at low rate (less than 80% for neutral electrolyte and less than 85% for alkaline electrolyte at 0.5 C) and low capacity at high rate (less than 40 mAh g⁻¹). In sharp contrast, after applying a layer of Ni/C nanoparticles at the positive electrode, the battery delivered a reversible capacity of 118, 117, 100 and 88 mAh g⁻¹ at current density of 0.5 C. 1 C. 5 C and 10 C respectively. (FIG. 4a). The battery with a layer of Ni/C nanoparticles at the positive electrode displayed an impressive stability during high rate. Besides, the gradually decreased discharge average voltage (DAV) of the batteries cycled in neutral and alkaline electrolyte also indicated the instable nature of aqueous batteries, which would compromise the energy density during both cycling and storage (FIG. 4b). However, the surface treatment of the positive electrode can effectively stabilise DVA at low rate and also guarantee the battery a high DVA (˜1.2 V) at high rate of 10 C. Then, the cycling performance of the batteries was examined at a low rate of 0.5° C. in FIG. 5. The capacity of batteries using the surface treatment of the positive electrode was much higher than other systems. More importantly, the batteries cycled in neutral electrolyte showed a pretty low Coulombic efficiency which was lower than 80% and also gradually decreased due to severe side reactions. After adding NaOH in the electrolyte to increase the pH, the Coulombic efficiency increased to 85% due to suppression of HER. However, after applying a layer of Ni/C nanoparticles at the positive electrode, the Coulombic efficiency greatly increased to over 96%. The battery with the surface treatment of the positive electrode can also achieve an improved performance at 1 C with no obvious capacity fading (FIG. 4c). More importantly, the battery with the surface treatment of the positive electrode can stably cycle under a harsh environment of −30° C. with a capacity retention of 86% at 0.5° C. after 200 cycles (FIG. 4d), which exceeds most previous reported aqueous batteries¹⁸⁻¹⁹. Most importantly, the battery with the surface treatment of the positive electrode achieved an unprecedented long-cycling life of over 14000 cycles at 10 C as well as a favorable capacity retention of 56% with high electrode loadings (˜20 mg cm⁻¹. FIG. 4c).

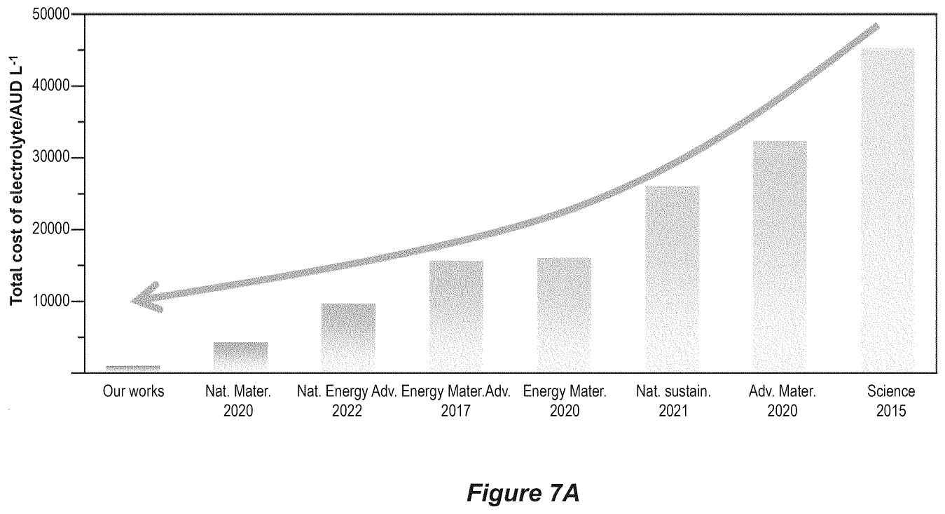

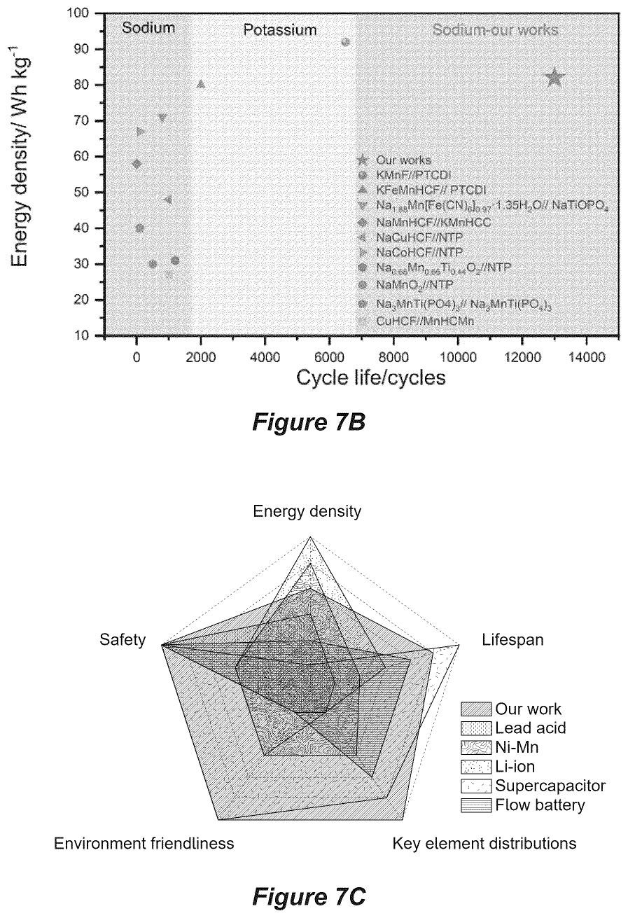

The current work was compared with previous reported works. As seen in FIG. 6 and Table 1, among recently reported sodium aqueous batteries, the battery according to the present disclosure possesses the highest electrode loading and energy density, the longest lifespan, as well as the lowest costs. Even if the average voltage is limited due to limitations of the electrodes, it still can reach a high value of 1.4 V. Compared with recently reported aqueous Li, Na, K batteries with favorable stability using expensive F-contained salts, our work, which uses cheap NaClO₄ single water solution, produced undeniable advantages. As seen in FIG. 7a (the prices of salts are based on the data from the sigma in Australia and the costs of solvents are overlooked), the costs of regular WIS electrolytes are very expensive, such as 21 m bis(trifluoromethane) sulfonimide lithium salt (LiTFSI)², 21 m KOTF¹⁹ and 9 M NaOTF²⁰. Some researchers have introduced a large number of organic solvents to reduce the use of salts as well as the costs, but these caused safety problems²¹⁻²³. In sharp contrast, by using a single water solvent NaClO₄ solution with the surface treatment strategy, the electrochemical device of the present disclosure can achieve good electrochemical performance at very low cost (at least 40 times less than regular WIS strategy based on F-contained salts). Due to the relatively limited storage and high price of Li, aqueous Li ion batteries may not be suitable for large-scale energy storage. Thus, the inventors compared the recently reported aqueous Na and K batteries in relation to energy density and lifespan (FIG. 7b). Even with limitations by the electrodes, the energy density of the ASIB of the present disclosure is slightly lower than one previously reported work. However, the lifespan of the battery according to the present disclosure (14000 cycles) is twice that of the battery at second place (6500 cycles). The ASIB of the present disclosure is a promising candidate for practical application in large-scale energy storage. Then, the inventors compared this ASIB with other electrochemical storage systems. As can be seen in FIG. 7c and Table 2, even if the energy density of the ASIB of the present disclosure is lower than Li-ion and Ni—Mn batteries, it demonstrates remarkable advantages in respect of abundance of the key elements, safety, environmental friendliness over all other batteries and has an ultra-long lifespan, which makes it a promising candidate for large-scale energy storage.

TABLE 1
Comparison of recently reported sodium aqueous batteries

| | Average | | Energy | Cathode | Electrolyte cost |
|---|---|---|---|---|---|
| | voltage | Cycling | density | loading | (AUD based on the |
| System | (V) | life | (Wh kg⁻¹⁾ | (mg/cm⁻²) | price in sigma) |
| Ni/C coated NMF/NTP | 1.4 | 13000 | 82 | 20.45 | 1040.6 |
| Na₃V₂(PO₄)₃//NTP³ | ~1.1 | 100 | ~64 | 5 | Over 15665.8 |
| Na_{0.66}Mn_{0.66}Ti_{0.44}O₂//NTP⁴ | 1 | 1200 | 31 | — | 16124.0 |
| Na_{1.88}Mn[Fe(CN)₆]_{0.97}•1.35H₂O//NaTiOPO₄⁵ | 1.74 | 800 | 71 | — | Over 15665.8 |
| NaMnHCF//KMnHCC⁶ | 1.7 | 100 | 58 | 1.7 | 330461.6 |

TABLE 2
Comparison of our works with commercial batteries

| | Abundance of key | | Energy | | | |
|---|---|---|---|---|---|---|
| | elements in the | | density | | Environment | Cost- |
| System | Earth's crust | Lifespan | (Wh kg⁻¹) | Safety | friendliness | efficacy |
| Ni/C coated | Fe (41000) | 15000 | ~50 | High | High | High |
| NMF/NTP | Mn (950) | | | | | |
| | Na (23000) | | | | | |
| | Ti (5600) | | | | | |
| | Ni (80) | | | | | |
| Lead-acid^{7,8} | Pb (14) | 300-1000 | 25-40 | High | Low | High |
| Ni—MH²⁴ | Ni (80) | 200-1200 | 50-85 | Medium | Medium | Medium |
| | La (32) | | | | | |
| Li-ion | Li (20) | 160-2000 | 160 | Low | Medium | Medium |
| (LFP/graphite)¹⁶ | | | | | | |
| Supercapacitor²⁴ | C (480) | 5000-10⁵ | 5-10 | High | High | Low |
| Flow battery | V (120) | 5000-10⁴ | 10-25 | High | Low | Medium |
| (Vanadium | | | | | | |
| redox | | | | | | |
| battery)^{7,8} | | | | | | |

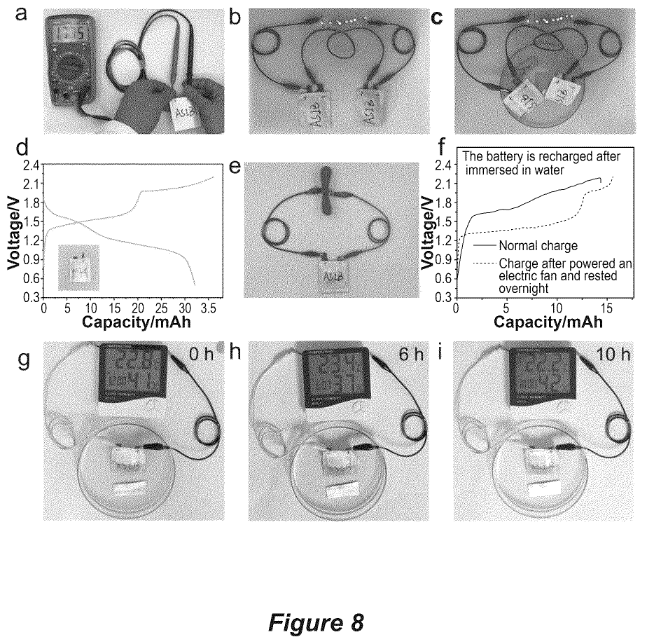

Safety is one of the key parameters to evaluate the effectiveness of a battery system suitable for large-scale energy storage. Thus, the inventors assembled an NMF/NTP cell to conduct tests under very harsh environments. As seen in FIG. 8a, the output voltage of the pouch cell is 1.775 V, which is much higher than normal sodium aqueous batteries. Benefiting from this high voltage, two cells can power the blue lights (the lower voltage requirement of blue light is 3 V). More intriguingly, the pouch cell displayed incomparable stability in the cut experiment (FIG. 8c). The pouch cell can be cut and immersed in water without its function of powering the lights being compromised. The high capacity of the pouch cells also showed a strong performance of powering an electric fan before or after being cut and immersed in water (FIG. 8e). Besides, the pouch cell can be recharged to 2.2 V after being cut and powered a fan in water, displaying an outstanding stability (FIG. 8f). Most importantly, the recharged cut pouch cell can continuously power a hygrometer in water over 10 hours (FIGS. 8g-h). This means the batteries can withstand electrolyte leaks in high humidity environments (even in the water) without causing serious damage to the whole system while maintaining the ability to power an electric equipment, which leads to a great improvement in the safety of large-scale energy storage and multiple applications in underwater electrical equipment.

### DISCUSSIONS

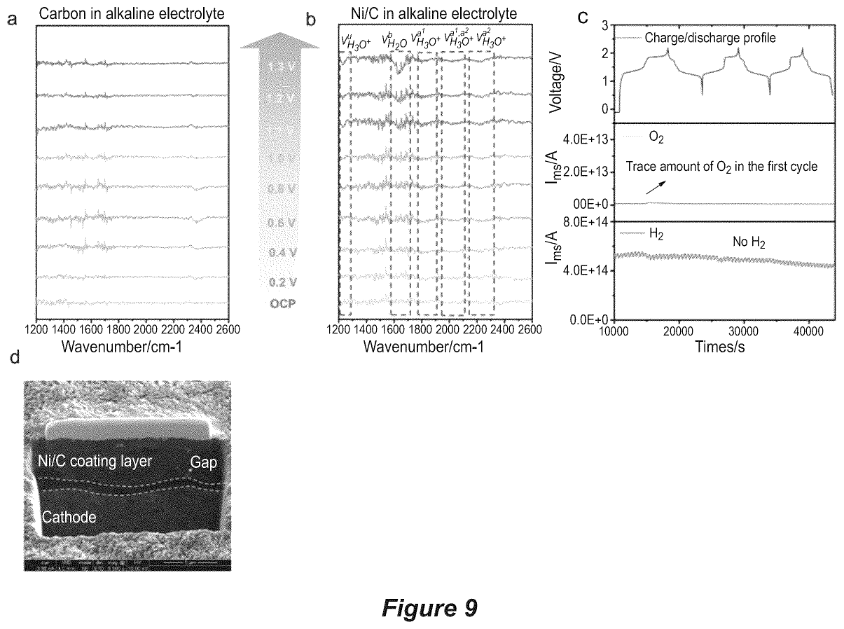

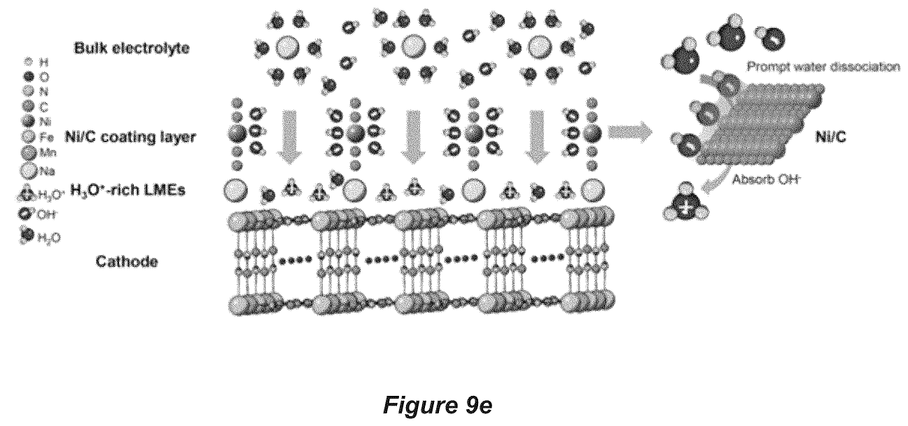

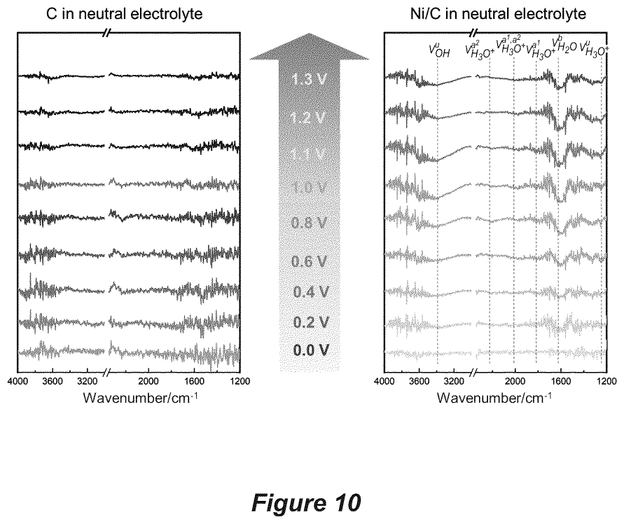

The unprecedented electrochemical performance of electrochemical devices of the present disclosure can be attributed to the local hydronium ion rich environment created at the positive electrode. In order to test the assumptions, in-situ IR was used to verify the generation of H₃O⁺ (FIGS. 9a and 9b). To rule out the influence from the electrolyte and nanoparticles per se, reference spectra (with no potential applied) were taken as background for each group of tests. Carbon black (C) was taken as a control group to eliminate the influence of the polymer support and carbon per se. As expected, there is no obvious change in the spectra of C even the voltage raised to 1.3 V, indicating the C and polymer support cannot create a local hydronium ion rich environment. In contrast, for the Ni/C in the alkaline electrolyte, new peaks showed up with an applied potential higher than 0.6 V. The peaks at 2218 cm⁻¹ and 1810 cm⁻¹ appeared, which could be attributed to the two asymmetric O—H stretching modes of

$${H}_{3} {O}^{+} ( {v}_{{H}_{3} {O}^{+}}^{{a}^{1}} and {v}_{{H}_{3} {O}^{+}}^{{a}^{1}} ,$$

FIG. 9a). Moreover, the peak of the resonance state of the asymmetric O—H stretching modes of H₃O⁺ at 2020 cm⁻¹

$$( {v}_{{H}_{3} {O}^{+}}^{{a}^{1} + {a}^{2}} ) ,$$

as well as the distinct and isolated peak at 1230 cm⁻¹ corresponding to the umbrella vibration

$${H}_{3} {O}^{+} ( {v}_{{H}_{3} {O}^{+}}^{u} ) ,$$

also appeared in the spectrum. To conclude, the in-situ IR has provided clear evidence for the generation of H₃O⁺.

The Ni/C coating layer (FIG. 9d) induces a gap between the coating layer and the cathode layer, which can accommodate the H₃O⁺ and separate it from the bulk alkaline electrolyte. Ni nanoparticles can promote water dissociation, which has been proved in previous catalysis studies^{25,26}. As a result, large amounts of H⁺ and OH⁻ are produced around this layer due to the water dissociation, as illustrated in FIG. 9c. The strong interaction between Ni and OH⁻ helps to confine OH⁻ on the surface of the Ni nanoparticles which makes it difficult to escape to the surrounding solution. However. H⁺ has poor interaction with Ni nanoparticles in an alkaline medium and will bond with nearby water molecules to form H₃O⁺. These H₃O⁺ ions exposed to the bulk alkaline electrolyte will be easily neutralized by excess OH. In contrast, due to the blocking effect of the coating layer. H₃O⁺ ions will accumulate underneath the layer, leading to a H₃O⁺-rich environment on the cathode surface, which in turn suppresses OER during the battery operation.

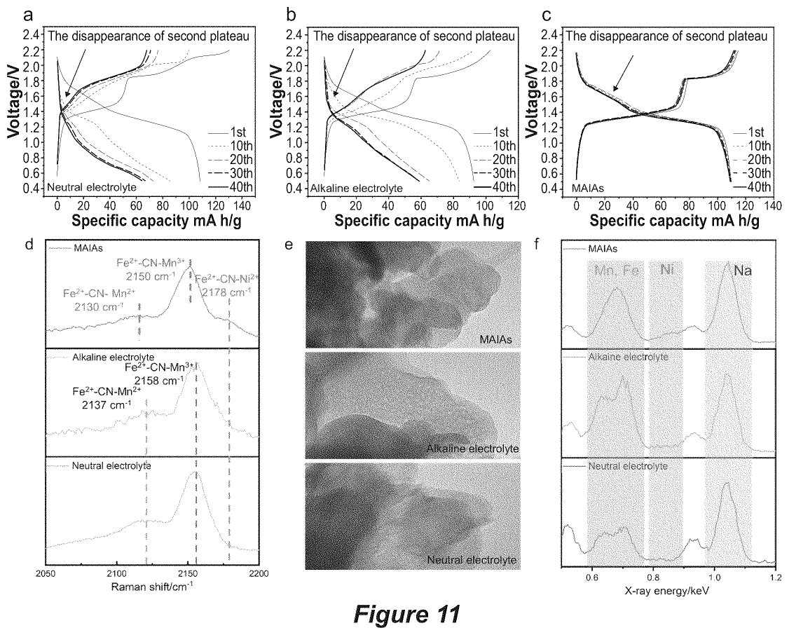

The high pH of electrolyte not only causes the OER of water, but also intensifies the issue of cathode dissolution. Prussian Blue Analogues (PBAs) are promising cathode materials for sodium batteries due to their environmental friendliness and facile intercalation/deintercalation mechanism^{27,28}. However, hydroxide anions can interact with N-coordinated metal atoms and then rupture the PBAs^{29,30}. Besides, some OH species will adsorb at a cathode with operating potentials close to the OER, further promoting detrimental side reactions³¹. Moreover, this problem is aggravated in Mn-rich PBAs like NMF due to Mn dissolution driven by the disproportionation reaction of Mn³⁺ and Jahn-Teller (JT) distortion³². As shown in FIGS. 11a and 11b, the second plateau is missing in the charge-discharge curves of the NMF/NTP electrodes in the neutral electrolyte and alkaline electrolyte due to the above-mentioned reasons. However, for the batteries after application of the surface treatment to the positive electrode, the second plateau is ultra-stable even after 40 cycles (FIG. 11c). It is believed that there are two major contributions to the ultra-stability of the PBA cathode in alkaline electrolyte. First, as mentioned above, a local hydronium ion rich environment at the cathode was created by the surface treatment of the positive electrode. Then, the H₃O⁺ rich surface layer prevents the OH species from adsorbing onto the surface of the cathode, therefore reducing dissolution of Mn. Secondly, according to literature³³, the capacity and cycling performance can be improved for Mn-based electrodes if electrochemically active cations (such as Ni²⁺ and Co²⁺) are substituted for the Mn. Thus, it is believed that this unusual stability of NMF also can be attributed to the in-situ substituted Ni²⁺ for Mn due to the oxidation of Ni particles in the nanoparticle layer during the charging process. In this regard. Raman spectroscopy was applied to verify our assumption (FIG. 11d). Peaks in the range of 2050˜2200 cm⁻¹ in Raman, which were assigned to the CN⁻ groups, indicate that the transition-metal ions bonded to the CN groups exhibit different valence states³⁴. In Raman spectra of NMF electrodes cycled in neutral and alkaline electrolyte, there are three peaks at 2137 cm⁻¹ and 2158 cm⁻¹ belonging to Fe²⁺—N≡C—Mn²⁺ and Fe²⁺—N≡C—Mn³⁺ vibrations respectively. In comparison, the Raman spectrum of the positive electrode with the surface treatment cycled in alkaline electrolyte presented two shifted peaks at 2130 cm⁻¹ and 2150 cm⁻¹ respectively. In addition, a new weak peak attributing to Fe²⁺—N≡C—Ni²⁺ is observed at 2163 cm⁻¹. All of these changes suggest that Ni was being introduced into the structure of NMF after it was cycled in alkaline electrolyte with local microenvironment (LME). Then TEM and EDS spectra were also used to verify the existence of Ni in the cathode. As seen in FIG. 11e, the crystal structure of NMF is well preserved after applying the layer of nanoparticles, but the crystal structure is destroyed in neutral electrolyte and alkaline electrolyte. EDS of cycled NMF cathode also indicates the existence of the Ni peak at 0.82 keV (FIG. 11f).

In summary, it is demonstrated that the surface treatment strategy disclosed herein can greatly improve the stability of aqueous electrolyte as well as the Mn-based cathode without compromising the low cost and environmental friendliness of sodium aqueous batteries. This strategy can enable an ultra-long lifespan and high energy density sodium aqueous batteries, while maintaining cost effectiveness, environment friendliness and toleration of low-temperature. More importantly, pouch cells using the surface treatment of the positive electrode strategy can achieve an unprecedented stability even after being cut and immersed in water. This represents a significant advancement in the design of aqueous batteries, both in concept and demonstration, and sets a new performance standard that promises to yield battery systems that exceed previous energy density and practical application limitations while reducing or eliminating the need for changing the battery industry infrastructure, have high compatibility with current commercial Li-ion and Na-ion battery systems, and do not need the expensive moisture-free process and the safety management required for flammable electrolytes. It is believed that the batteries based on this strategy could promote the application of aqueous batteries in large-scale energy storage and underwater equipment due to the abundance of the raw materials used, low cost, environmental friendliness, long lifespan, ultra-high stability, safety in water environment, and favourable energy density.

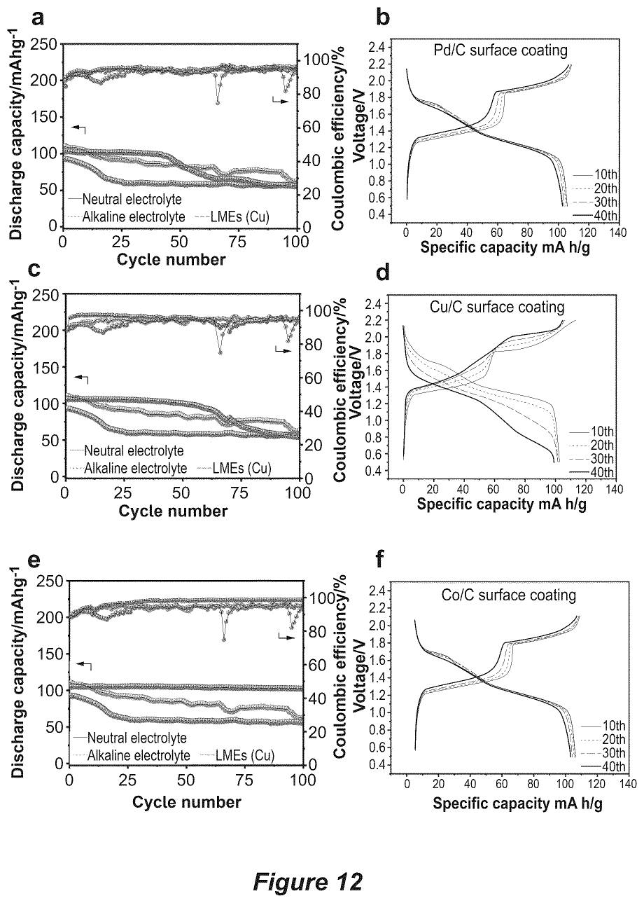

In addition to Ni, other metal nanoparticles were also explored in the alkaline ASIB system, including Pd, Cu, and Co (FIG. 12). Co nanoparticles also can effectively stabilise the NMF/NTP cells in alkaline electrolyte. This indicates the applicability of creating a local environment to put the high-performance alkaline ASIBs into practice.

### Experiments in Relation to Cathode Sacrifice Strategy

Preparation of Na₂MnFe(CN)₆ (NMF) Positive Electrode and NaTi₂(PO₄)₃ (NTP) Negative Electrode

The NMF and the NTP were prepared as stated above except that no nanoparticles layer was applied onto the surface of the positive electrode

### Preparation of Aqueous Electrolyte

The aqueous electrolyte was prepared as stated above.

### Results and Discussions

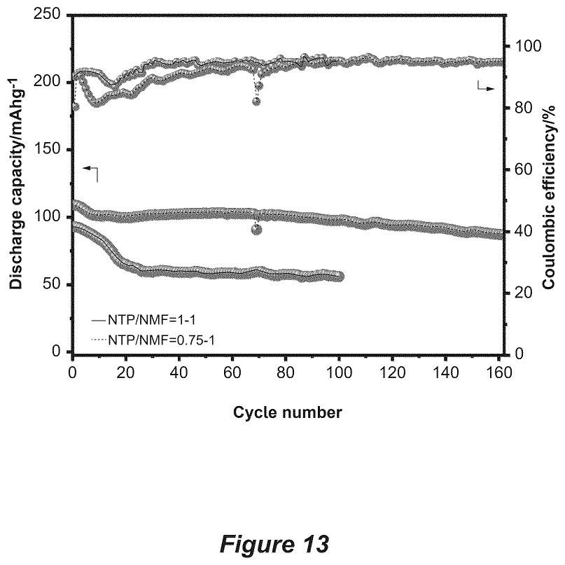

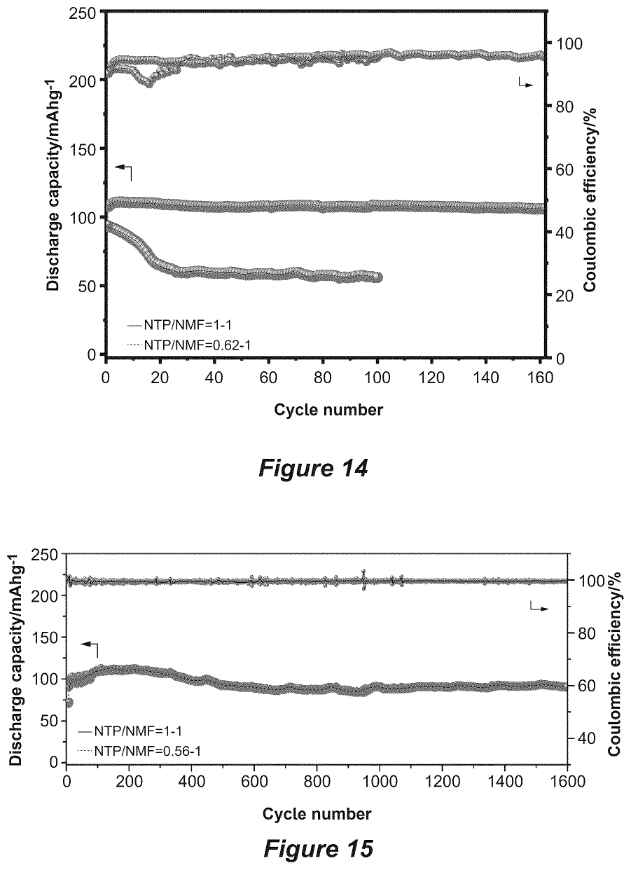

In some circumstances, the mass ratio between negative electrode and positive electrode can be reduced to less than 1, so as to improve the stability of batteries. When the mass ratio of NTP/NMF is 1:1, without presence of the nanoparticle layer, the batteries exhibit rapid capacity fading at 1 C in 25° C. However, if reducing the mass ratio between NTP and NMF to 0.75:1, the stability of batteries can be greatly improved, and the batteries achieved a capacity retention of 90% at 1 C in 25° C. (FIG. 13). When reducing the mass ratio between NTP and NMF to 0.62:1, the stability of battery was further improved (FIG. 14). When the mass ratio was reduced to 0.56:1, the battery maintained 90% capacity at high rate of 10 C (compared with capacity in 1 C, FIG. 15). It also maintained a nearly 100% capacity retention at 10 C after 1600 cycles at 25° C. (FIG. 15).

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

### REFERENCES

[1] Niu, C. et al. Balancing interfacial reactions to achieve long cycling life in high-energy lithium metal batteries. Nature Energy 6, 723-732 (2021).
[2] Zheng, Q. et al. A cyclic phosphate-based battery electrolyte for high voltage and safe operation. Nature Energy 5, 291-298 (2020).
[3] Hu, L. et al. Nonflammable electrolyte enhances battery safety. Proceedings of the National Academy of Sciences 111, 3205-3206 (2014).
[4] Hammami, A. et al. Runaway risk of forming toxic compounds. Nature 424, 635-636 (2003).
[5] Xu, C. et al. Nature-inspired hierarchical materials for sensing and energy storage applications. Chemical Society Reviews 50, 4856-4871 (2021).
[6] Chen, W. et al. A manganese-hydrogen battery with potential for grid-scale energy storage. Nature Energy 3, 428-435 (2018).
[7] Soloveichik, G. L. J. N. Metal-free energy storage. Nature 505, 163-164 (2014).
[8] Suo, L. et al. “Water-in-salt” electrolyte enables high-voltage aqueous lithium-ion chemistries. Science 350, 938-943 (2015).
[9] Abraham, K. J. A. E. L. How comparable are sodium-ion batteries to lithium-ion counterparts? ACS Energy Letters 5, 3544-3547 (2020).
[10] Jiang, L. et al. Building aqueous K-ion batteries for energy storage. Nature Energy 4, 495-503 (2019).
[11] Xue, L. et al. Cathode dependence of liquid-alloy Na—K anodes. Journal of the American Chemical Society 140, 3292-3298 (2018).
[12] Zhou, A. et al. Size-, water-, and defect-regulated potassium manganese hexacyanoferrate with superior cycling stability and rate capability for low-cost sodium-ion batteries. Small 15, 1902420 (2019).
[13] Jiang, L. et al. High-voltage aqueous Na-ion battery enabled by inert-cation-assisted water-in-salt electrolyte. Advanced Materials 32, 1904427 (2020).
[14] Li, W. et al. Lithium intercalation from aqueous solutions. Journal of the Electrochemical Society 141, 2310 (1994).
[15] Luo, J.-Y. et al. Raising the cycling stability of aqueous lithium-ion batteries by eliminating oxygen in the electrolyte. Nature chemistry 2, 760-765 (2010).
[16] Kim, H. et al. Aqueous rechargeable Li and Na ion batteries. Chemical Reviews 114, 11788-11827 (2014).
[17] Han, J. et al. Fluorine-free water-in-salt electrolyte for green and low-cost aqueous sodium-ion batteries. ChemSusChem 11, 3704-3707 (2018).
[18] Jiang, L. et al. Building aqueous K-ion batteries for energy storage. Nature Energy 4, 495-503 (2019).
[19] Ge, J. et al. Surface-substituted Prussian blue analogue cathode for sustainable potassium-ion batteries. Nature Sustainability, 1-10 (2021).
[20] Suo, L. et al. “Water-in-salt” electrolyte makes aqueous sodium-ion battery safe, green, and long-lasting. Advanced Energy Materials 7, 1701189 (2017).
[21] Xu, J. et al. Aqueous electrolyte design for super-stable 2.5 V LiMn₂O₄∥Li₄Ti₅O₁₂ pouch cells. Nature Energy 7, 186-193 (2022).
[22] Xie, J. et al. Molecular crowding electrolytes for high-voltage aqueous batteries. Nature materials 19, 1006-1011 (2020).
[23] Shang, Y. et al. An “ether-in-water” electrolyte boosts stable interfacial chemistry for aqueous lithium-ion batteries. Advanced Materials 32, 2004017 (2020).
[24] Wang, X. et al. Anomalous hydrogen evolution behavior in high-pH environment induced by locally generated hydronium ions. Nature communications 10, 1-8 (2019).
[25] Ghosh, S. et al. Multifold enhancement in water dissociation with Ag/Ni bimetallic alloy surfaces. Surface Science 701, 121695 (2020).
[26] Hundt, P. M. et al. Vibrationally promoted dissociation of water on Ni (111). Science 344, 504-507 (2014).
[27] Zhu, K. et al. Low defects potassium cobalt hexacyanoferrate as a superior cathode for aqueous potassium ion batteries. Journal of Materials Chemistry A 8, 21103-21109 (2020).
[28] Li, L. et al. A Low-Strain Potassium-Rich Prussian Blue Analogue Cathode for High Power Potassium-Ion Batteries. Angewandte Chemie International Edition 60, 13050-13056 (2021).
[29] Yang, Y. et al. Quantitative measurement of cyanide released from Prussian Blue. Clinical Toxicology 45, 776-781 (2007).
[30] Stilwell, D. et al. Electrochemical studies of the factors influencing the cycle stability of Prussian Blue films. Journal of Applied Electrochemistry 22, 325-331 (1992).
[31] Lamprecht, X. et al. Electrolyte effects on the stabilization of prussian blue analogue electrodes in aqueous sodium-ion batteries. ACS Applied Materials 2022, 14, 2, 3515-3525 (2022).
[32] Thackeray, M. et al. Electrochemical extraction of lithium from LiMn₂O₄. Materials Research Bulletin 19, 179-187 (1984).
[33] Zhan, C. et al. Dissolution, migration, and deposition of transition metal ions in Li-ion batteries exemplified by Mn-based cathodes—a critical review. Energy Environmental Science 11, 243-257 (2018).
[34] Li, W. et al. Stress distortion restraint to boost the sodium ion storage performance of a novel binary hexacyanoferrate. Advanced Energy Materials 10, 1903006 (2020).

1. An aqueous electrochemical device comprising a negative electrode, a positive electrode, a separator and an aqueous electrolyte having an alkaline pH, wherein the positive electrode has disposed thereon at least one layer of nanoparticles capable of forming a local hydronium ion rich environment at the positive electrode during operation of the device, and/or the capacity ratio between the negative electrode and the positive electrode is less than 1 so as to substantially avoid production of oxygen at the positive electrode.

2. A method of fabricating an aqueous electrochemical device according to claim 1, wherein the method includes applying onto the positive electrode at least one layer of nanoparticles capable of being used to form a local hydronium ion rich environment at the positive electrode during operation of the device, and/or making the capacity ratio between the negative electrode and the positive electrode less than 1 so as to substantially avoid production of oxygen at the positive electrode.

3. The device according to claim 1, wherein the aqueous battery is an aqueous metal-ion battery.

4. The device according to claim 3, wherein the aqueous battery is an aqueous lithium-ion battery, an aqueous sodium-ion battery, or an aqueous potassium-ion battery.

5. The device according to claim 1, wherein the nanoparticles are made from a support and any one selected from the group consisting of Ni, Pt, Fe, Co, Pd, Cu and combinations thereof.

6. The device according to claim 5, wherein the support within the nanoparticles is selected from the group consisting of carbon black, carbon nanotubes, graphite, graphitised carbon black, graphene, reduced graphene oxide and combinations thereof.

7. The device according to claim 1, wherein the nanoparticles are selected from the group consisting of Ni/C, Pt/C, Fe/C, Co/C, Pd/C, Cu/C, PtNi/C, PtFe/C, PtCo/C, PtCu/C, PdNi/C, Ni/rGO, Pt/rGO, Fe/rGO, Co/rGO, Pd/rGO, Cu/rGO, PtNi/rGO and PdNi/rGO nanoparticles.

8. The device according to claim 7, wherein the nanoparticles are Ni/C and/or Co/C nanoparticles with a Ni and/or Co loading of about 1% by weight to about 40% by weight.

9. The device according to claim 1, wherein the average particle size of the nanoparticles ranges from about 1 nm to about 100 nm.

10. The device according to claim 1, wherein the at least one layer of nanoparticles has a thickness of about 5 μm to 100 μm.

11. The device according to claim 1, wherein the pH of the aqueous electrolyte is about 9 to about 13.

12. The device according to claim 1, wherein the aqueous electrochemical device is an aqueous sodium ion battery, the aqueous electrolyte having an alkaline pH comprises a salt as the electrolyte which is selected from sodium perchlorate (NaClO₄), sodium trifluoromethanesulfonate (NaCF₃SO₃), sodium nitrate (NaNO₃), sodium chloride (NaCl), sodium sulfate (Na₂SO₄), sodium acetate (CH₃COONa), sodium carbonate (Na₂CO₃), sodium hexafluorophosphate (NaPF₆), and combinations thereof.

13. The device according to claim 12, wherein the aqueous electrolyte having an alkaline pH is a saturated aqueous solution of sodium perchlorate.

14. The device according to claim 1, wherein the aqueous electrochemical device is an aqueous sodium ion battery, the positive electrode comprises a positive electrode material which is selected from the group consisting of NaₓFe_{y}Mn_{1-y}[Fe(CN)₆]_{w}·zH₂O (1≤x≤2, 0.8≤y≤1, 0.8≤w≤1, 0.5≤z≤2), Na₂MnₓFe₁₋ₓFe(CN)₆ (0.8≤x≤1), Na₂MnₓNi₁₋ₓFe(CN)₆ (0.8≤x≤1), Na₂MnₓCo₁₋ₓFe(CN)₆ (0.8≤x≤1.0), Na₃V₂(PO₄)₂F₃, Na_{0.44}MnO₂, Na₂NiFe(CN)₆, Na₂CuFe(CN)₆, Na₂NiMn(CN)₆, Na₃V₂(PO)₄, NaMnO₂, Na_{0.66}[Mn_{0.66}Ti_{0.34}]O₂, and Na₂Zn₃[Fe(CN)₆]₂, Na₃MnTi(PO₄)₃ and Na₄Fe₃(PO₄)₂(P₂O₇).

15. The device according to claim 1, wherein the aqueous electrochemical device is an aqueous sodium ion battery, the negative electrode comprises a negative electrode material which is selected from the group consisting of NaTi₂(PO₄)₃, Na₃MnTi(PO₄)₃, NaTiOPO₄, Na₂VTi(PO₄)₃, Na₃V₂(PO₄)₃, TiSe₂, TiS₂, hard carbon and perylenetetracarboxylic diimide.

16. The device according to claim 1, wherein the capacity ratio between the negative electrode and the positive electrode is about 0.56:1 to about 0.95:1.

17. The device according to claim 16, wherein the capacity ratio between the negative electrode and the positive electrode is about 0.62:1.

18. The device according to claim 16, wherein the capacity ratio between the negative electrode and the positive electrode is about 0.75:1.

19. A positive electrode for an aqueous electrochemical device, which has disposed thereon at least one layer of nanoparticles capable of forming a local hydronium ion rich environment at the positive electrode during operation of the device.

20. The positive electrode according to claim 19, wherein the nanoparticles are selected from the group consisting of Ni/C, Pt/C, Fe/C, Co/C, Pd/C, Cu/C, PtNi/C, PtFe/C, PtCo/C, PtCu/C, PdNi/C, Ni/rGO, Pt/rGO, Fe/rGO, Co/rGO, Pd/rGO, Cu/rGO, PtNi/rGO and PdNi/rGO nanoparticles.
